(19) United States
(12) Patent Application Publication
(10) Pub. No.: US 2002/0071559 A1
(43) Pub. Date: Jun. 13, 2002

(54) Method and apparatus for providing electronic data

(76) Inventors: Jakob Hjorth Christensen, Copenhagen (DK); Lars Floe Nielsen, Copenhagen (DK); Michael Seifert, Copenhagen (DK); Jacob Surland, Slangerup (DK); Ole Sas Thrane, Valby (DK)

Correspondence Address: BIRCH STEWART KOLASCH & BIRCH, PO BOX 747, FALLS CHURCH, VA, 22040-0747, US

(21) Appl. No.: 09/731,852

(22) Filed: Dec. 8, 2000

Related U.S. Application Data
(60) Provisional application No. 60/219,409, filed on Jul. 20, 2000.

(51) Int. Cl. H04L 9/08

(52) U.S. Cl. 380/277; 705/51

(57) ABSTRACT

Method and apparatus for preventing illegal copying of copyright material. Encrypted data is transmitted from a first computer to a second computer, and the decryption key has to be requested each time the user want to gain access to the data in an unencrypted form. The encryption key is subsequently rendered unfit for use and/or the decrypted data is rendered unfit for use. The decryption key may be stored in a non-accessible part of a hardware processor of the second computer. Access to the data in an unencrypted form, e.g. the number of copies, may thus be controlled. Further, a method of distributing electronic data from a number of publishers to a number of recipients. Each publisher makes data available from e.g. a web site, and the recipients may purchase the data via a global computer network. The data is distributed in a safe manner as described above. Makes it possible to publish small editions of data while still protecting the copyright.

### FIELD OF THE INVENTION

The present invention relates to a method and apparatus for providing electronic data, in particular the kind of data being subject to a copyright, from one computer to another computer. More specifically the invention relates to providing the electronic data in a safe manner so as to prevent unintended (i.e. seen from the copyright holder's point of view) and/or illegal copying of or access to the data, e.g. in order to protect the copyright of the owner of the data.

The present invention further relates to a method of distributing such electronic data to a number of recipients in a safe manner

### BACKGROUND OF THE INVENTION

U.S. Pat. No. 5,889,860 assigned to Sunhawk Corporation, Inc., discloses an encryption system with transaction coded decryption key. The system discourages wrongful redistribution of protected information such as digital musical scores, and allows for tracking of infringing activity. A client using the system is assigned a password that is specific to the client and transaction, and the password functions as a decryption key. Thus, any subsequent redistribution of the musical score together with the decryption password can be traced. That is, if wrongful redistribution is performed and subsequently detected, the person who has originally obtained the musical score and performed the redistribution may be identified. This fact discourages the person from performing the redistribution.

U.S. Pat. No. 5,509,074 assigned to AT&T Corp. discloses a method of protecting electronically published materials using cryptographic protocols. The disclosed method comprises the user requesting documents, said request including unique user identification. The document is encrypted with a unique identification before it is forwarded to the user, and the user needs to know said unique identification in order to gain access to the document. The unique identification is based upon personal information, such as a credit card number or other sensitive information which the user will not be inclined to pass on to other persons. Thereby the user is discouraged from redistributing the documents

U.S. Pat. No. 5,892,900, assigned to InterTrust Corp., discloses a method for protecting one or more programs from analysis or alteration, wherein application modules are being decrypted during the loading process and unencrypted data are only stored at a main memory for a limited time interval.

None of the above references provides a system which is capable of preventing the user from redistributing the obtained document/musical score. Both the systems merely discourages the user from doing so.

### SUMMARY OF THE INVENTION

It is an object of the present invention to provide a method and apparatus for providing electronic data which prevents as well as discourages wrongful redistribution of electronically obtained data.

It is a further object of the present invention to provide a method of distributing electronic data via a computer network, where the distribution can be managed in a controlled manner so that only a correct number of copies is distributed to a specific recipient, and so that wrongful redistribution of electronically obtained data is prevented as well as discouraged.

According to a first aspect of the present invention there is provided a method of providing electronic data from a first computer to a second computer, the method comprising the steps of:

1: at least partially encrypting the data with an encryption key (K_{g}) in the first computer, said encryption key (K_{g}) having a corresponding decryption key (K_{d}),

2: communicating the at least partially encrypted data from the first computer to he second computer,

3: the second computer requesting the decryption key (K_{d}) from the first computer,

4: the first computer providing the decryption key (K_{d}) to the second computer,

5: the second computer decrypting the at least partially encrypted data using the decryption key (K_{d}),

6: rendering the decryption key (K_{d}) unfit for use,

7: outputting the data to an output device,

The electronic data being provided may be documents, such as text files, sheet music, blueprints etc., or it may be other kinds of electronically available data, such as musical files (e.g. MP3 files), movies (or cuts from movies), computer programmes, electronic games, or any other suitable kinds of data, preferably of the kind being subject to a copyright.

The data is at least partially encrypted, i.e. at least part of the data file is encrypted with an encryption key (K_{g}), said encryption key (K_{g}) having a corresponding decryption key (K_{d}). K_{g} is preferably a random secret encryption key which is generated by the first computer in a manner which is known per se. But the encryption may alternatively be performed in any other suitable (known) manner, such as by means of a public key system or by means of a constructed (e.g. by means of various information received from the user) key. The whole of the data file may be encrypted, but alternatively a part, such as a part comprising the title, an abstract, the price etc. may be left non-encrypted. K_{g} may be a symmetric key in which case K_{d} is equal to K_{g}.

The encrypted data is preferably communicated from the first computer to the second computer by means of a computer network connecting the two computers. Most preferably the computer network is a global computer network, but it may alternatively or additionally be a local computer network, such as a Local Area Network (LAN), or even a network connecting only the two computers in question. Alternatively, the data may be communicated to the second computer by means of a storage medium, such as a floppy disc, a compact disc, a DVD disc or any other suitable kind of storage medium. In this embodiment K_{d} may subsequently be obtained on-line from the first computer. This embodiment is particularly useful when one wishes to distribute the encrypted data to a large number of people, e.g. by delivering compact discs free with a magazine, or if books being sold in very limited editions are to be distributed in book stores. Such books may be printed on demand on a printer situated in the book store. The embodiment described above allows for only one pair of encryption/decryption keys to be associated with a specific bunch of data. Obviously, this results in a lower security level than would be the case if a unique pair of encryption/decryption keys was provided every time a user requests the data, since a one-to-one relation between the user and K_{g}/K_{d} is not present. However, the above described embodiment is easier to handle in case a large number of recipients is wanted, and may therefore be applied in some cases.

When a one-to-one relation between the user and K_{g}/K_{d} is provided a further security is present since a user will be discouraged from attempting to circumvent the system, since a successful attempt would result in a great risk of the user being discovered as the one having circumvented the system. Since the encryption is performed in real-time any encrypted data may be watermarked, visibly and/or invisibly, before the encryption is performed, using methods which are known per se. Such a watermark can contain information about the user who has performed the purchase in case such information was required before the data was communicated to the second computer. This even further discourages the user from tampering with the encrypted material.

When the second computer decrypts the at least partially encrypted data it does so using the obtained decryption key (K_{d}).

After use (i.e. after K_{d} has been used to decrypt the encrypted data) K_{d} must be rendered unfit for use. This must be done in order to prevent the user from gaining access to K_{d}. That is, K_{d} may only be obtained and used temporarily, and the user may not at any time gain direct access to K_{d}. Preferably, K_{d} is obtained only by a client program which is installed on the second computer, and K_{d} is obtained in a secret manner, i.e. in such a way that the user can not in any way gain direct access to K_{d}. If the user of the required data for some reason needs to gain access to the decrypted data again, he or she must request K_{d} once more from the first computer via the client program. K_{d} may be rendered unfit for use by deleting or erasing it from the second computer after the decryption has taken place, e.g. by storing it in a volatile memory of the second computer only. When in the present context the term ‘volatile memory’ is used it should be interpreted as meaning a memory in which the data is not stored in a permanent way. A volatile memory could e.g. be the random access memory (RAM) of a personal computer (PC). In case K_{d} is stored in a volatile memory only, it will automatically be erased from the second computer when the decryption process is finished. It will also be impossible for the user to gain access to K_{d} in such a way that K_{d} may be saved in a more permanent storage medium, such as a hard disc or a compact disc, or passed on to a third party. Alternatively, K_{d} may be rendered unfit for use in any other suitable way, such as by destroying at least part of K_{d}, as long as it is ensured that it can only be obtained or used temporarily for the decryption process.

The output device may be a printing device, such as a printer, a telefax, or any other suitable kind of printing device. It may alternatively be a computer screen, a processing unit of a computer, a play back device, or any other suitable kind of output device, depending on the kind of data in question. In case the data is a musical file or a movie (or part(s) of a movie), the output device preferably comprises a play back device being able to play the music/movie, preferably comprising one or more loudspeakers, a monitor (in case of a movie), and control means for controlling the playback (start, stop, rewind, fast forward etc.) within the limits of the permissions given along with the provision of the decryption key.

K_{d} may be encrypted separately before it is provided to the second computer. This makes the transfer of K_{d} even more safe. Furthermore, K_{d} may be stored in an encrypted form in a volatile memory of the client program. Thus, K_{d} can not be intercepted by the user or by any software installed on the second computer (e.g. by eavesdropping or memory inspection).

Preferably, step 2 of the method further comprises the step of branding the at least partially encrypted data with an identifier (Iᵤ) in the first computer, and step 3 is preferably performed by the second computer providing the identifier (Iᵤ).

The branding provides a link between the encrypted data and Iᵤ, and ensures that Iᵤ is sent, non-encrypted, to the second computer along with the encrypted data. Preferably, Iᵤ is further stored in the first computer together with K_{g} and/or K_{d}, thereby linking them. When the second computer subsequently requests K_{d} by providing Iᵤ, the first computer will instantly know which decryption key to provide. K_{g} and/or K_{d} and Iᵤ may be stored in a database in the first computer, and they may be stored along with other relevant data pertaining to the distribution, such as customer ID, invoice number, distribution batch etc. Such other relevant data may be added at a later time, e.g. when K_{d} is requested by the second computer.

Preferably, Iᵤ is a unique, most preferably a globally unique, identifier being generated by the first computer.

Step 4 of the method may comprise the steps of:

determining whether the second computer fulfils one or more predetermined criteria selected from a group of criteria,

providing the decryption key (K_{d}) only if the second computer fulfils one or more of said predetermined criteria.

The term ‘predetermined’ should be interpreted as meaning ‘fixed in advance’ for each transaction. ‘The predetermined set of criteria’ may thus very well be a dynamic entity, which may be adjusted occasionally, e.g. in order to comply with a certain transaction, or it may be ‘globally’ adjusted in case it is discovered that some of the criteria are inappropriate and should be changed or removed accordingly, and/or that other criteria should be added to the group of criteria.

The group of criteria may consist of,

the time elapsed between the encryption of the data and the request for the decryption key (K_{d}) does not exceed a predetermined time interval,

the decryption key (K_{d}) has not been requested more than a predetermined number of times,

the second computer is a predetermined computer,

valid payment has been provided,

the hardware being used by the second computer is a predetermined hardware,

the e-mail address of the user is a predetermined e-mail address,

the user name of the user is a predetermined user name,

the output device is a predetermined type of output device,

the output device driver is a predetermined output device driver,

the network ID is a predetermined network ID.

The predetermined time interval is preferably between 1 day and 14 days, such as between 3 days and 10 days, such as between 5 days and 8 days, such as approximately 7 days. This criterion could be selected in order to be able to delete associated data from the first computer after the predetermined time has elapsed, thus saving storage space in the first computer.

Alternatively or additionally, this criterion could be selected in order to make the vendor capable of providing e.g. time limited offers, time based subscriptions, automatic obsoletion of old or outdated material, and/or to ensure that time limited agreements, such as distribution contracts, expire when the contract between the vendor and the copyright holder expires, so as to prevent that the vendor accidentally distributes material which it is no longer entitled to distribute. Such applications may of course require other time intervals than the ones mentioned above. The time interval may thus be set individually in each case.

The predetermined number of times is preferably between 1 time and 10 times, such as between 2 times and 7 times, such as approximately 3 times. This criterion may be selected in order to allow the user to decrypt the data only a certain number of times. Ideally the user should only be allowed to decrypt the data once, but since something may go wrong during the download, the decryption or in any other part of the process, the provider may choose to let the user gain access to the data a limited number of times, so as to ensure that the user gets what he or she pays for, i.e. a decrypted version of the data. However, the number of times may also be larger, e.g. in case a teacher needs to buy copies for his or her entire class. In this case the user buys the relevant number of copies, and the number is explicitly set for each session, that is the user will always be asked to enter the number of copies he or she wishes to purchase. The user may e.g. be a book store purchasing the right to print and sell a specific number of copies of a specific book. In the case the predetermined number is preferably a large number, e.g. 1,000 or 10,000.

The term ‘a predetermined computer’ may cover a specific type of computer, and/or it may cover a specific computer device, e.g. having a specific IP address or a specific hardware ID. This criterion may, e.g., be used in order to ensure that the decryption key is not provided to a computer which is somehow capable of preventing the step of rendering the decryption key (K_{d}) unfit for use, e.g. by storing K_{d} in a non-volatile memory. There may be provided a ‘positive list’ listing a number of types of computers which may be used or a ‘negative list’ listing a number of types of computers which may not be used. Alternatively, a ‘negative list’ listing specific computers belonging to ‘unwanted persons’ may be provided, e g. in order to avoid that such ‘unwanted persons’ gain access to decrypted data. The ‘unwanted persons’ may e.g. be persons who already owe a large amount of money to the provider, and who is unwilling to or uncapable of paying this amount of money, or it may be persons who have been known to illegally distribute copyright protected data in the past. A ‘positive list’ may be generated during the request step for a specific session, the list consisting of only one specific computer. Thereby the output step is limited to being performed from that specific computer only. Alternatively or additionally, this criterion may be used to ensure that the data is not provided to a location which is within an area or a country being subject to an embargo (e.g. a US trade embargo), since the location of the second computer may be determined based upon e.g. the IP address of the computer.

The term ‘valid payment’ will be further described below.

The term ‘predetermined hardware’ may cover any kind of hardware being used in connection with the second computer, including the computer itself monitors, printing devices or any other kind of hardware. The notes above regarding the computer applies equally here.

The e-mail address or the user name of the user may be used as criteria. They may be used in order to ensure that the person obtaining the encrypted data is also the person obtaining the decryption key. Alternatively, the user may specify an e-mail address or a user name being different from his/her own for the delivery of the encrypted data and/or the decryption key. Thus, the user may present the data as a gift, in which case the user pays the bill, while the data is decrypted by the person receiving the gift. The criteria may also be used in order to prevent certain persons from gaining access to the decrypted data as described above.

When K_{d} is requested for the first time, K_{d} may be associated with an ID of the second computer requesting K_{d}. This ID then forms the basis for a ‘positive list’ containing e.g. only the ID of this single computer as described above. Thus, subsequently, a criterion may be used that further access to this particular data may only be granted from this specific computer having this specific ID. This is particularly useful in case the data is presented as a gift as described above, since the data will not be bound to a specific computer until the person receiving the gift requests K_{d} for the first time. That is, it is possible to order the data and to obtain the data in an encrypted form without providing any information to the first computer. In case the user has obtained the right to gain access to the data from, e.g., two different computers, the ID of the second computer will also be associated with K_{d} the first time K_{d} is requested from this computer.

The term ‘predetermined type of output device’ may cover the actual type of output device, such as ‘printer’, ‘monitor’, ‘play back device’ etc. Alternatively, it may cover certain subtypes, such as certain types of printers, monitors, play back devices etc. As described above, a ‘positive list’ or a ‘negative list’ may be provided. Thus, a ‘negative list’ may, e.g., comprise printers which are known to be able to store print jobs in a decrypted version, whereby the user may be capable of producing more copies of a document than was intended.

Similarly, a ‘predetermined output device driver’ may be required, the output device driver being the software controlling the output device. The notes above are equally applicable here.

In order to identify the type of output device driver checksums, hashes, or similar digital signatures of the output device driver and/or other output device programs may be employed. In this way it may be determined whether a driver/program is actually the driver/program it appears or claims to be. If the signature of a driver/program turns out to be different from what was expected, the driver/program is definitely not the driver/program it claims to be, i.e. the driver/program has been altered. In this case it may be decided that the decryption key can not be provided to the second computer, since the alterations may e.g. be of such a kind as to allow for the decrypted data to be stored in the memory of the output device, thereby circumventing the system. Using checksums is somewhat less definitive but nevertheless obtaining a different checksum than expected indicates that alterations have been performed as described above, and accordingly the provision of the decryption key may be denied.

Similarly to requiring a predetermined hardware ID, a predetermined network ID may be used as a criterion.

Step 4 of the method may be performed using an encrypted session between the first computer and the second computer. Such an encrypted session is known per se, e.g. from the sessions used when a bank customer gains access to banking activities from a personal computer being connected to the computer of the bank via a global computer network (known as ‘home banking’).

In a preferred embodiment step 7 is performed by dividing the at least partially encrypted data into a number of subparts, each subpart in turn being output to an output device. Thus, all of the decrypted data is not output to the output device at once. Most preferably this has the effect that all of the decrypted data is never contained in a memory of the output device.

Preferably, step 7 is performed at least substantially simultaneously with step 5, in such a way that each subpart of the data is in turn decrypted and output to the output device. In this embodiment all of the decrypted data is never contained in any memory connected to the second computer, i.e. memories of the second computer and/or any other related hardware. This may be performed by streaming the data to the output device.

The method may further comprise the step of providing payment to the first computer. This step may comprise the step of charging a credit card, in which case it may further comprise the steps of:

entering relevant credit card data,

the first computer checking whether the corresponding credit card is valid and chargeable.

The credit card data may be entered via a client program which is installed on the second computer.

This is a very common way of providing payment when performing purchase via a global computer network, e.g. in case of e-commerce or the like. In one embodiment credit card data may be provided by the user before the decrypted data is communicated to the second computer (i.e. the vendor ‘reserves’ the amount due on the user's account), but the account of the user is not charged until the decryption key is requested by the second computer (‘capture’).

Alternatively, the step of providing payment may comprise the step of charging a smart card, or it may be performed by charging an account which the user has established at the vendor, or by using ‘cyber cash’ or an ‘electronic wallet’, i.e. by charging an account which the user has established for the purpose of being able to charge said account when performing e-commerce, and from which any amount, also very small amounts, may be withdrawn.

The method may further comprise the steps of

a: the second computer re-requesting the decryption key (K_{d}),

b: the first computer providing the decryption key (K_{d}) to the second computer,

c: the second computer decrypting the at least partially encrypted data,

d: rendering the decryption key (K_{d}) unfit for use,

e: outputting the data to an output device.

These steps may be performed in case the user for some reason needs to gain access to the decrypted data once more. This may be the case if the user has purchased the right to access the decrypted data a number of times (i.e. more than once), or if something went wrong the first time the user tried to decrypt and output the data, so that the user did not receive the decrypted data in a proper way, or if the user did not want to decrypt the data immediately after having received the encrypted data, but rather wanted to wait, e.g. for a day, before decrypting the data. The above mentioned steps have already been described.

Most preferably, the first computer keeps track of the number of times the above steps are performed, i.e. it keeps track of the number of times K_{d} is requested by the second computer, in order to avoid that the user gains access to the decrypted data more times than he/she is supposed to.

Step d may comprise deleting the decryption key (K_{d}) from the second computer after the data has been output to the output device

In case the additional steps a-e above are performed, the method may further comprise the step of providing payment to the first computer. The user may thus pay for an additional copy of the decrypted data. This step may be performed as described above.

The method may comprise the step of providing electronic data from a server device to a client device. In this case the first computer is preferably a server device and the second computer is preferably a client device.

The method may further comprise the steps of:

the first computer requesting additional information from the second computer,

the second computer providing said additional information,

the first computer using said additional information for determining whether to provide the decryption key (K_{d}) or not.

The step of the second computer providing said additional information may comprise the step of the user providing at least some of said additional information.

These steps may be performed in case the first computer does not have sufficient information regarding the user and/or regarding the second computer and/or regarding any hardware or software connected to the second computer to determine whether the decryption key (K_{d}) may be provided. The steps are most preferably performed in embodiments where K_{d} is only provided if the second computer fulfils one or more criteria, and the additional information will in this case relate to one or more of said criteria. The additional information may relate to the second computer or other hardware/software matters, e.g. hardware ID, software being installed on the second computer, e-mail address/user name etc. Such information may be provided automatically be the second computer without the user even noticing. Alternatively, the additional information may be more user specific, such as credit card data in order to provide valid payment, or the number of copies the user wishes to purchase, in which case providing the additional information requires an active act from the user. In this case the user will preferably be asked to enter the relevant information by means of a prompt being presented at the monitor of the second computer.

The features of the first aspect of the invention may be combined with any of the features of the second, third, fourth, fifth, sixth, and seventh aspects of the invention.

The invention also relates to a computer program system for providing electronic data from a first computer to a second computer, the computer program system being adapted to:

1: at least partially encrypt the data with an encryption key (K_{g}) in the first computer, said encryption key (K_{g}) having a corresponding decryption key (K_{d}),

2: communicate the at least partially encrypted data from the first computer to the second computer,

3: provide a request for the decryption key (K_{d}) from the second computer to the first computer,

4: cause the first computer to provide the decryption key (K_{d}) to the second computer,

5: cause the second computer to decrypt the at least partially encrypted data using the decryption key (K_{d}),

6: render the decryption key (K_{d}) unfit for use,

7: output the data to an output device.

It should be understood that the computer program system may further be adapted to perform any of the operations discussed above and below in connection with the methods of the present invention.

The invention further relates to a computer readable data carrier loaded with such a computer program system, and to a computer system operatively connected to such a computer readable data carrier.

In the present text, the term “computer program system” should be understood as any computer program or any system of a plurality of computer programs adapted to perform the required operations.

In the present text, the term “computer readable data carrier” should be understood as any device or media capable of storing data which is accessible by a computer or a computer system. Thus, a computer readable data carrier may, e.g., comprise a memory, such as RAM, ROM, EPROM, or EEPROM, a floppy or a hard disk drive, a CD ROM, a DVD, a data tape, or a DAT tape.

According to a second aspect of the invention there is provided a method of providing electronic data from a first computer to a second computer, the method comprising the steps of:

1: at least partially encrypting the data with an encryption key (K_{g}) in the first computer, said encryption key (K_{g}) having a corresponding decryption key (K_{d}),

2: the second computer requesting the decryption key (K_{d}) from the first computer,

3: the first computer providing the decryption key (K_{d}) to the second computer,

4: communicating the at least partially encrypted data from the first computer to the second computer,

5: the second computer concurrently receiving and decrypting, by means of a decryption computer program, the at least partially encrypted data, and outputting the data to a selected data output computer program for outputting a signal representative of the decrypted data to a selected software program or hardware device, the data output computer program being known to render the decrypted data unfit for use after output thereof to the selected software program or hardware device,

6: rendering the decrypted data unfit for use.

In this embodiment the first computer may divide the encrypted data into subparts before it is communicated to the second computer. The second computer then receives the subparts, decrypt them and output them to the output device. This is done concurrently, i.e. in such a way that the data is not found completely and in a decrypted form anywhere in the second computer. Step 6 may be performed concurrently with step 5 so as to ensure this.

The selected data output computer program may be a driver for an output device, such as a printer driver, a driver for a viewing program, a driver for an audio program, or any other suitable kind of driver, depending on the kind of data being output as well as on the type of output device. In this case a signal representative of the data is preferably output to a selected hardware device rather than to a selected software program. Alternatively, it may be a program which prepares the data for a software program, such as a data processing program, a viewer program, a game, or any other suitable kind of software program. In this case the data is preferably output to a selected software program rather than to a selected hardware device.

Since the data output computer program is known to render the decrypted data unfit for use after output thereof to the selected software program or hardware device it is ensured that a decrypted version of the data can not be stored at the second computer. Thus, in order to obtain another copy of the data, it is necessary to re-request the decryption key from the first computer. The number of copies being provided to the user can thus be controlled.

The method may further comprise the step of rendering the decryption key (K_{d}) unfit for use. This may be done by deleting the decryption key (K_{d}) from the second computer after step 5 has been performed as described above

Step 5 may comprise the steps of:

dividing the at least partially encrypted data into a number of subparts,

decrypting each subpart in turn,

outputting each subpart in turn to the selected data output computer program,

outputting a signal representative of each subpart in turn to the selected software program or hardware device,

step 6 in this case comprising the step of:

rendering each subpart unfit for use after it has been output to the selected data output computer program as described above.

Preferably, each subpart is rendered unfit for use before the subsequent subpart is decrypted.

Step 5 may be performed by outputting the data to a printer device using a printer driver, the printer driver being of a type being known to render the data unfit for use after output thereof to the printer device.

Step 3 may comprise the steps of;

determining whether the second computer fulfils one or more predetermined criteria selected from a group of criteria,

providing the decryption key (K_{d}) only if the second computer fulfils one or more of said predetermined criteria,

and the group of criteria may consist of,

the time elapsed between the encryption of the data and the request for the decryption key (K_{d}) does not exceed a predetermined time interval,

the decryption key (K_{d}) has not been requested more than a predetermined number of times,

the second computer is a predetermined computer,

valid payment has been provided,

the hardware being used by the second computer is a predetermined hardware,

the e-mail address of the user is a predetermined e-mail address,

the user name of the user is a predetermined user name,

the output device is a predetermined type of output device,

the output device driver is a predetermined output device driver,

the network ID is a predetermined network ID.

This has already been described above. The criterion of the output device driver being a predetermined output device driver may be used in such a way that it is checked whether the output device driver is actually of a kind being known to render the decrypted data unfit for use after output thereof to the selected software program or hardware device.

In case the output device is a printer, the data may be streamed from the second computer to the printer via the selected data output computer program.

The features of the second aspect of the invention may be combined with any of the features of the first, third, fourth, fifth, sixth, and seventh aspects of the invention

The invention further relates to a computer program system of providing electronic data from a first computer to a second computer, the computer program system being adapted to:

1: at least partially encrypt the data with an encryption key (K_{g}) in the first computer, said encryption key (K_{g}) having a corresponding decryption key (K_{d}),

2: cause the second computer to request the decryption key (K_{d}) from the first computer,

3: cause the first computer to provide the decryption key (K_{d}) to the second computer,

4: communicate the at least partially encrypted data from the first computer to the second computer,

5: cause the second computer to concurrently receive and decrypt, by means of a decryption computer program, the at least partially encrypted data, and output the data to a selected data output computer program for outputting a signal representative of the decrypted data to a selected software program or hardware device, and cause the data output computer program to render the decrypted data unfit for use after output thereof to the selected software program or hardware device,

6: render the decrypted data unfit for use.

It should be understood that the computer program system may further be adapted to perform any of the operations discussed above and below in connection with the methods of the present invention.

The invention further relates to a computer readable data carrier loaded with such a computer program system, and to a computer system operatively connected to such a computer readable data carrier.

According to a third aspect of the invention there is provided a computer system for providing electronic data comprising

a first computer,

a second computer,

an output device,

the first computer comprising

encryption means for at least partially encrypting data with an encryption key (K_{g}), said encryption key (K_{g}) having a corresponding decryption key (K_{d}),

first communication means for communicating the at least partially encrypted data to the second computer,

providing means for providing the decryption key (K_{d}) to the second computer on request,

the second computer comprising

second communication means for receiving the at least partially encrypted data from the first computer,

requesting and receiving means for requesting and receiving the decryption key (K_{d}) from the first computer,

decryption means for decrypting the at least partially encrypted data,

outputting means for outputting the data to the output device,

means for rendering the decryption key (K_{d}) unfit for use.

The electronic data to be provided may be any suitable kind of electronically available data, as has already been described. The output device may accordingly be any suitable kind of output device depending on the kind of data. The output device may thus be a printing device, such as a printer, a telefax or any other suitable printing device, or it may be a monitor, or it may comprise play back means, such as loudspeakers or a TV screen.

The encryption means, the decryption means and/or the providing means preferably comprises software being suitable for controlling the associated processes.

The means for rendering the decryption key (K_{d}) unfit for use may comprise deleting means for deleting the decryption key (K_{d}) after the data has been decrypted. Such deleting means most preferably deletes the decryption key automatically, i.e. without any action from the user, Alternatively or additionally, the means for rendering the decryption key (K_{d}) unfit for use may comprise erasing means for erasing the decryption key (K_{d}) after the data has been decrypted. This has been further described previously.

Most preferably, the first computer is a server device and the second computer is a client device. In this case the two computers are most preferably connected via a computer network, being either a global or a local computer network.

The first communication means and/or the second communication means may thus comprise a global computer network.

The first computer may further comprise means for receiving payment. The payment is preferably received as described above, and the means for receiving payment is accordingly suitable for performing the corresponding acts. The means for receiving payment may, e.g., comprise means for checking the validity and chargeability of a credit card.

The outputting means for outputting the data to the output device may comprise a data output computer program for outputting a signal representative of the decrypted data to a selected software program or hardware device. In this case the data output computer program is known to render the decrypted data unfit for use after output thereof to the selected software program or hardware device.

This has been described above.

The features of the third aspect of the invention may be combined with any of the features of the first, second, fourth, fifth, sixth, and seventh aspects of the invention.

According to a fourth aspect of the invention there is provided a method of transferring data from a computer system to an output device, the computer system comprising a first computer and a plurality of second computers, said first computer and said second computers being interconnected via a computer network, the data being present at at least one of the second computers, the method comprising the steps of:

1: sending, by means of said at least one second computer, a request to the first computer for permission to output the data to the output device, said request including an identification of the output device,

2: checking, by means of the first computer, whether the output device is an allowed type of output device,

3: the first computer providing an answer to the request to the second computer, he answer including a permission to output the data to the output device if the output device is of an allowed type,

4: if the output device is of an allowed type: outputting the data from the second computer to the output device.

The first computer is preferably a server device, e.g. an internet server, and each of the plurality of second computers is preferably a client device, e.g. a personal computer (PC), such as a PC being positioned in the private home of a person wishing to output the data to an output device, or a PC being positioned at a central position, such as in a book store. In the latter case the PC may be used for printing various kinds of printed material, such as books, poems, sheet music etc., on demand.

The computer network interconnecting the first computer and the second computers may be a global computer network, such as the internet, or it may be a local computer network, e.g. a Local Area Network (LAN), or it may be any other suitable kind of computer network.

The identification of the output device being included in the request for permission to output the data to the output device may comprise various kinds of information relating to the output device hardware, the output device software (e.g. the driver) and/or any other suitable kind of information. This will be described further below.

The step of checking whether the output device is an allowed type of output device is performed on the basis of the information provided as described above.

According to this aspect of the invention it is possible to prevent a user from outputting data if the outputting process can not be performed in a satisfying manner, i.e. in a manner which prevents unintentional and/or illegal copying of the data. It may e.g. be prevented that the data is output to an output device which may store the data in the output device or in the second computer, thereby making it possible to control the number of copies being output. That is, the data may only be output if specific permission is given from the first computer.

The data may have been previously obtained, e.g. by downloading it, preferably from the first computer, or the data may have been received on a CD ROM, or it may have been obtained in any other suitable way.

An advantage of this aspect of the invention is that e.g. a positive list comprising allowed types of output devices and/or negative lists comprising not-allowed types of output devices may be updated in a central place, i.e. in the first computer. Since new output device drivers (e.g. printer drivers) are released almost on a daily basis it is a great advantage that it is possible to check the kind of output device using an updated list without having to distribute this updated list to a large number of recipients of data.

Step 2 may be performed by, by means of the first computer, comparing the type of output device with a predefined positive list of allowed types of output devices. In this case the answer of step 3 includes a permission to output the data to the output device only if the type of output device is present on said predefined positive list.

Alternatively or additionally, step 2 may be performed by, by means of the first computer, comparing the type of output device with a predefined negative list of not-allowed types of output devices. In this case the answer of step 3 includes a permission to output the data to the output device only if the type of output device is not present on said predefined negative list.

The concept of positive/negative lists has been described previously.

Step 2 may be performed by, by means of the first computer, checking whether the output device comprises an allowed type of hardware and/or by, by means of the first computer, checking whether the output device comprises an allowed type of output driver. Preferably, it is checked that neither the hardware nor the output driver is capable of causing a decrypted version of the data to be stored in the second computer or in any hardware being directly connected to the second computer. It may e.g. be checked that the output device is not a telefax (or another kind of output device being capable of storing the data), that the output device driver is of a kind being known to render the data unfit for use after the output thereof to the output device, and/or any other suitable criteria may be checked.

The answer of step 3 may further include a decryption key for decrypting encrypted electronic data. In this case the output of the data may be controlled as described above, since the data can only be decrypted and subsequently output when permission thereto is given from the first computer.

The output device may comprise a printer, in which case step 4 may be performed by printing the data using the printer. Alternatively or additionally the output device may comprise an audio driver, playback means, loudspeakers, a video monitor, a computer monitor, one or more computer programs, and/or any other suitable kind of means depending on the nature of the data to be output.

The request of step 1 may include an identification of the driver of the output device as mentioned above.

The features of the fourth aspect of the invention may be combined with any of the features of the first, second, third, fifth, sixth, and seventh aspects of the invention. In particular it may be combined with any of the features of the first aspect.

The invention also relates to a computer program system for transferring data from a computer system to an output device, the computer system comprising a first computer and a plurality of second computers, said first computer and said second computers being interconnected via a computer network, the data being present at at least one of the second computers, the computer program system being adapted to:

1: send, by means of said at least one second computer, a request to the first computer for permission to output the data to the output device, said request including an identification of the output device,

2: check, by means of the first computer, whether the output device is an allowed type of output device,

3: cause the first computer to provide an answer to the request to the second computer, the answer including a permission to output the data to the output device if the output device is of an allowed type,

4: if the output device is of an allowed type: output the data from the second computer to the output device.

It should be understood that the computer program system may further be adapted to perform any of the operations discussed above and below in connection with the methods of the present invention.

The invention further relates to a computer readable data carrier loaded with such a computer program system, and to a computer system operatively connected to such a computer readable data carrier.

According to a fifth aspect of the invention there is provided a method of providing electronic data from a first computer to a second computer, the second computer comprising an output device, the method comprising the steps of:

1: at least partially encrypting the data with an encryption key (K_{g}) in the first computer, said encryption key (K_{g}) having a corresponding decryption key (K_{d}),

2: communicating the at least partially encrypted data from the first computer to the second computer,

3: the second computer requesting the decryption key (K_{d}) from the first computer,

4: checking whether the driver of the output device is an allowed type of driver,

5: the first computer providing the decryption key (K_{d}) to the second computer only if said driver is an allowed type of driver,

6: the second computer decrypting the at least partially encrypted data in case said decryption key (K_{d}) is provided,

7: outputting the decrypted data to the output device.

The encrypted data may be communicated from the first computer to the second computer via a computer network interconnecting the first computer and the second computer. Such a computer network may be a global computer network, such as the internet, or it may be a local computer network, such as a Local Area Network (LAN), or it may even be a direct connection interconnecting only the first computer and the second computer. Alternatively, the encrypted data may be communicated from the first computer to the second computer via a movable storage medium, such as a floppy disk or a CD ROM. In this case the encrypted data may be distributed to a large number of people, e.g. together with a magazine. The data may in this case be a special offer to people buying or subscribing to the magazine.

The request by the second computer for the decryption key (K_{d}) may preferably include information relating to the user, the second computer, hardware connected to the second computer, software connected to the second computer, and/or any other relevant information which the first computer may use as a basis for determining whether or nor it is safe to provide the decryption key (K_{d}) to the second computer. Most preferably the request includes information relating to the output device, in particular to the type of driver of the output device, since the decryption key (K_{d}) is only provided if the driver is of an allowed type.

The decryption step is performed by using the provided decryption key (K_{d}).

The output device may be a printer, in which case step 7 is performed by printing the data using the printer.

Step 4 may be performed by comparing the type of driver with a predefined positive list of allowed types of drivers, in which case step 5 is only performed if the driver is of a type which is present on said predefined positive list.

Similarly, step 4 may be performed by comparing the type of driver with a predefined negative list of not-allowed types of drivers, in which case step 5 is only performed if the driver is of a type which is not present on said predefined negative list.

The concept of positive/negative lists has been described previously.

The method may further comprise the step of rendering the decryption key (K_{d}) unfit for use. As previously described, this may e.g. be done by deleting the decryption key (K_{d}) from the second computer after step 6 has been performed or by storing the decryption key (K_{d}) in a volatile memory of the second computer only.

The method may further comprise the steps of.

the second computer concurrently receiving and decrypting, by means of a decryption computer program, the at least partially encrypted data, and outputting the data to a selected data output computer program for outputting a signal representative of the decrypted data to a selected software program or hardware device, the data output computer program being known to render the decrypted data unfit for use after output thereof to the selected software program or hardware device,

rendering the decrypted data unfit for use.

It is thereby ensured that the decrypted data is not be stored in the second computer in a permanent way, and unintentional or illegal copying of the data is thereby prevented. This has been described previously.

The method may further comprise the steps of:

a: the second computer re-requesting the decryption key (K_{d}),

b: checking whether the driver of the output device is an allowed type of driver,

c: the first computer providing the decryption key (K_{d}) to the second computer only if said driver is an allowed type of driver,

d: the second computer decrypting the at least partially encrypted data in case said decryption key (K_{d}) is provided,

e: outputting the decrypted data to the output device.

This may be useful if it is necessary for the user to gain access to the data more than once, e.g. if the user has obtained permission to obtain more than one copy of the data or if something went wrong the first time the decryption key was requested/provided. In the latter case it can be ensured that the user actually gets what he/she is paying for.

The number of times the decryption key may be requested can be limited. This has been described previously. It may be controlled in the following way.

The method may further comprise the step of, by means of a counter, counting the number of times the decryption key (K_{d}) has been provided to the first computer, said counting step being performed by augmenting said counter each time the decryption key (K_{d}) has been provided to the first computer, step c being performed only if the number of times the decryption key (K_{d}) has previously been requested does not exceed a predetermined number of times.

The predetermined number of times may be set according to the situation in question, e.g. according to the number of copies the user has paid for or it may be the minimum number of times required to ensure that the user gets at least one complete copy of the data. Such a minimum number may vary according to the complexity of e.g. the download process, the decryption process, the data itself and/or according to any other relevant conditions.

The method may further comprise the steps of:

determining whether the second computer fulfils one or more predetermined criteria selected from a group of criteria,

providing the decryption key (K_{d}) only if the second computer fulfils one or more of said predetermined criteria,

and the group of criteria may consist of,

the time elapsed between the encryption of the data and the request for the decryption key (K_{d}) does not exceed a predetermined time interval,

the decryption key (K_{d}) has not been requested more than a predetermined number of times,

the second computer is a predetermined computer,

valid payment has been provided,

the hardware being used by the second computer is a predetermined hardware,

the e-mail address of the user is a predetermined e-mail address,

the user name of the user is a predetermined user name,

the network ID is a predetermined network ID.

The use of such a group of criteria has been described previously.

The features of the fifth aspect of the invention may be combined with any of the features of the first, second, third, fourth, sixth, and seventh aspects of the invention.

The invention also relates to a computer program system for providing electronic data from a first computer to a second computer, the second computer comprising an output device, the computer program system being adapted to:

1: at least partially encrypt the data with an encryption key (K_{g}) in the first computer, said encryption key (K_{g}) having a corresponding decryption key (K_{d}),

2: communicate the at least partially encrypted data from the first computer to the second computer,

3: cause the second computer to request the decryption key (K_{d}) from the first computer,

4: check whether the driver of the output device is an allowed type of driver,

5: cause the first computer to provide the decryption key (K_{d}) to the second computer only if said driver is an allowed type of driver,

6: cause the second computer to decrypt the at least partially encrypted data in case said decryption key (K_{d}) is provided,

7: output the decrypted data to the output device.

It should be understood that the computer program system may further be adapted to perform any of the operations discussed above and below in connection with the methods of the present invention,

The invention further relates to a computer readable data carrier loaded with such a computer program system, and to a computer system operatively connected to such a computer readable data carrier.

According to a sixth aspect of the invention there is provided a method of decrypting data, the method utilising a hardware processor containing an inaccessible part, the method comprising, by means of said hardware processor:

storing, in the hardware processor, an encryption/decryption key (AS) comprising a public part (A) and a corresponding private part (B), the private part (B) of the key (AB) being stored in the inaccessible part of the hardware processor,

outputting the public part (A) of the key (AB) to an external processor or program,

receiving, from said external processor, an encrypted decryption key (E) which is encrypted by means of the public part (A) of the key (AB),

decrypting key (E) into the inaccessible part of the hardware processor by using the private part (B),

receiving data encrypted with encryption key (E),

decrypting the data using the decrypted key (E),

outputting the decrypted data.

The hardware processor may e.g. be a silicon chip of the kind which is often used in computer devices, i.e. it is of a kind being capable of storing information in an electronic form. Alternatively it may be a device, e.g. a smart card, which may be incorporated into other pieces of hardware, e.g. output devices such as printers, screens, etc.

It is well known how to transfer a decryption key, e.g. a symmetric key, securely from a first computer to a second computer. This can be done using per se known public key algorithms. However, using this method the decryption key is exposed on the second computer.

If using the described special purpose hardware, often described as smart cards, it is now possible to receive and store the decryption key in hardware such that it is never accessible to the second computer.

Using this technique has the advantage that the decryption key is never exposed to the recipient; only the decrypted data is exposed. By furthermore incorporating the hardware directly into devices such as printers, screens, sound and video devices, the decrypted data will for all practical purposes remain inaccessible in its digital form.

The term ‘inaccessible part’ should be understood as meaning a part of the chip to which it is not possible to gain access. That is, the user of the computer device as well as the computer device itself can not ‘see’ the information stored in the inaccessible part. In particular it is not possible to extract the information from the inaccessible part, e.g. in order to store the data in another (accessible) part of the hardware processor or in another storage medium, such as a hard disk, a CD ROM, a floppy disc or any other suitable kind of storage medium from which direct access may be gained to the stored data.

The fact that the private part (B) of the key (AB) is stored in the inaccessible part of the hardware processor thus means that it is not possible to gain direct access to the private part (B), e.g. in order to read the key, store it in an accessible medium or distribute it. The private part (B) is thus kept secret.

In this aspect of the invention a public-key algorithm is used, the system being known per se. In such a system the encryption/decryption key comprises a private part and a public part. The private part is only known by the person to which the key ‘belongs’, whereas the public part is publicly available.

The public part (A) of the key (AB) is output to the external processor or program in order to enable the external processor or program to encrypt the decryption key (B) by using, i.e., the public part (A), so that the encrypted decryption key may subsequently be decrypted in the hardware processor using the private part (B).

Decrypting the encryption key (E) into the inaccessible part means that direct access can not be gained to the decrypted encryption key. It may thus be ensured that the encryption key (E) can neither be abused for repeated decryption of the encrypted data, nor be copied to an accessible storage medium, e.g. for further distribution. Thereby access to the decrypted data may be controlled, i.e. unintentional or illegal copying may be prevented.

The decrypted data may also be stored in the inaccessible part of the hardware processor, thereby controlling the access to the decrypted data.

The outputting step may be performed by outputting the decrypted data to an output device, such as a printing device, a playback means, a monitor, a loudspeaker and/or any other suitable kind of output device depending on the nature of the data to be output.

Alternatively or additionally, the outputting step may be performed by outputting the data to a computer chip, such as a silicon chip, for further processing.

The method may further comprise the step of encrypting the key (E) externally to the hardware processor.

The method may further comprise the step of encrypting the data with an encryption key corresponding to the decryption key (E) externally to the hardware processor.

The method may further comprise the step of, by means of the hardware processor, generating and storing the encryption/decryption key (AB) in the hardware processor. In this case the key (AB) may be generated in a random manner every time a key is required, e.g. every time there is a need to gain access to data which must be sent in an encrypted form, e.g. via a computer network connection. Alternatively, a new key (AB) may be generated at certain time intervals, such as every 10 days, or a key (AB) may be generated or provided once and for all. Alternatively, the key (AB) may be provided or specified from an external device.

The method may further comprise the step of rendering the decryption key (E) unfit for use after the data has been decrypted. As described previously this may be done e.g. by deleting the decryption key (E) from the hardware processor or by storing the decryption key (E) in a volatile memory part of the inaccessible part of the hardware processor. The features of the sixth aspect of the invention may be combined with any of the features of the first, second, third, fourth, fifth, and seventh aspects of the invention

The invention further relates computer program system for decrypting data, the computer program system being adapted to co-operate with a hardware processor containing an inaccessible part the computer program system being further adapted to, in co-operation with the hardware processor:

store, in the hardware processor, an encryption/decryption key (AB) comprising a public part (A) and a corresponding private part (B), the private part (B) of the key (AB) being stored in the inaccessible part of the hardware processor,

output the public part (A) of the key (AB) to an external processor or program,

receive, from said external processor, an encrypted decryption key (E) which is encrypted by means of the public part (A) of the key (AB),

decrypt key (E) into the inaccessible part of the hardware processor by using the private part (B),

receive data encrypted with encryption key (E),

decrypt the data using the decrypted key (E),

output the decrypted data.

The invention also relates to an electronic processor applicable as the above-mentioned hardware processor, i.e. an electronic processor containing an inaccessible part, and being adapted to, in co-operation with a computer program system, to decrypt data and to:

store, in the hardware processor, an encryption/decryption key (AR) comprising a public part (A) and a corresponding private part (B), the private part (B) of the key (AB) being stored in the inaccessible part of the hardware processor,

output the public part (A) of the key (AB) to an external processor or program,

receive, from said external processor, an encrypted decryption key (E) which is encrypted by means of the public part (A) of the key (AB),

decrypt key (E) into the inaccessible part of the hardware processor by using the private part (B),

receive data encrypted with encryption key (E),

decrypt the data using the decrypted key (E),

output the decrypted data.

It should be understood that the computer program system may further be adapted to perform any of the operations discussed above and below in connection with the methods of the present invention.

The invention further relates to a computer readable data carrier loaded with such a computer program system, and to a computer system operatively connected to such a computer readable data carrier.

According to a seventh aspect of the invention there is provided a method of distributing electronic data via a computer network, said electronic data originating from a plurality of publishers, the method comprising the steps of:

1: each of the plurality of publishers making electronic data available from a first computer being connected to the computer network,

2: the first computer distributing electronic data to users on demand, and

3: the first computer controlling the usage of the electronic data being made available to each user.

The first computer is preferably a server device from where the distribution of electronic data is managed and controlled.

According to this aspect the invention may be used for creating a ‘global publishing house’, i.e. a ‘publishing house’ in which the published material is distributed via a global computer network. The ‘global publishing house’ may work in the following way. A publisher, being an author, a composer, a poet, an architect, or any other kind of person producing material being subject to a copyright, submits his or her material to the publishing house which in turn makes sure that the material is available from their web site. The publisher then establishes a link from his or her own homepage or web site to the web site of the publishing house. When a potential user enters the homepage/web site of the publisher, he or she may click the link and thereby gain direct access to the part of the web site of the publishing house containing the material of that particular publisher. The user may then buy the desired piece of material via the publishing house in a manner described above. The publishing house keeps track of how many copies are distributed of each piece of material, and in turn pays the publisher associated with the publishing house according to this. This is an easy and cheap way of publishing material, especially if only very limited editions are expected to be sold. In this case it may even be impossible to have the material published in a conventional manner. Alternatively, the publishing house may provide a hyper link to the publisher. Thereby a user may download the data directly via the homepage/web site of the publisher. The publisher may also choose to distribute the data via, e.g., CD's as described above. That is, persons who have created something which they wish to publish may do so in an easy and controlled manner, so that their copyrights are protected.

Step 3 may be performed by counting the number of times the electronic data has been made available, in which case usage of the data is prevented or limited in case said number of times exceeds a predetermined number of times.

Alternatively or additionally, step 3 may comprise the steps of:

at least partially encrypting the data with an encryption key (K_{g}) in the first computer prior to distributing the data, so that the data is distributed in an encrypted form, said encryption key (K_{g}) having a corresponding decryption key (K_{d}),

the user requesting the decryption key (K_{d}),

the first computer providing the decryption key (K_{d}) to the user,

decrypting the at least partially encrypted data using the decryption key (K_{d}),

rendering the decryption key (K_{d}) unfit for use,

outputting the data to an output device.

In this case the usage of the electronic data being made available to each user is controlled by using the principles of the first aspect of the invention. Thus, the step of rendering the decryption key (K_{d}) unfit for use may comprise deleting the decryption key (K_{d}) as described previously.

The decryption key (K_{d}) may be provided only if the user fulfils one or more predetermined criteria selected from a group of criteria, and the group of criteria may consist of:

the time elapsed between the encryption of the data and the request for the decryption key (K_{d}) does not exceed a predetermined time interval,

the decryption key (K_{d}) has not been requested more than a predetermined number of times,

the computer used by the user is a predetermined computer,

valid payment has been provided,

the hardware being used by the user is a predetermined hardware,

the e-mail address of the user is a predetermined e-mail address,

the user name of the user is a predetermined user name,

the output device being used by the user is a predetermined type of output device,

the output device driver being used by the user is a predetermined output device driver,

the network ID is a predetermined network ID.

This has been described previously.

The method may further comprise the steps of:

the first computer charging each user for the data made available to the user,

the first computer providing payment to each of the publishers.

In this case the electronic data may be sold, and the appropriate amount will be redistributed to the publisher, In some cases a fee will be subtracted from the amount charged before the publisher is paid in order to provide payment from the publisher to the publishing house for its services. Normally a correct amount will be charged from the user before access may be gained to the electronic data.

The amount charged may be dependent on the content of the distributed electronic data and on the number of copies made available to the user. Thus, different amounts may be charged for different pieces of material, similar to the fact that books in a bookstore have different prices. The amount charged may also depend on the number of different pieces of material being distributed.

The payment to each of the publishers may be dependent on the content of the distributed electronic data and on the number of copies being made available to the users. The remarks above are equally applicable here, since each publisher should receive payment according to which pieces of material belonging to him/her and the number of copies has been distributed.

The step of charging each user may be performed by charging a credit card of each user.

The amount charged may be determined by the individual publisher. The amount may be determined as described above, i.e. depending on the content and the number of copies. Each publisher may thus determine a price for each of the pieces of material he or she makes available. Each publisher may also determine the conditions on which access is gained to the data by a user. For example a publisher may determine that if a user pays a certain amount he or she may gain access to the data up to 10 times from up to 3 different computers within 6 days.

Step 1 may be performed by, by means of the first computer, providing a Uniform Resource Locator (URL) corresponding to each piece of electronic data being made available to the respective publisher. Thus a user may gain access to the corresponding piece of electronic data via the URL.

In one embodiment the Uniform Resource Locator(s) (URL(s)) is/are placed on a web site belonging to the respective publisher, so as to provide a direct link from said web site to the electronic data. In this case a user may gain access to the data directly from the web site of the publisher. The publisher may in this case perform marketing from his or her web site.

Alternatively or additionally, the Uniform Resource Locator(s) (URL(s)) is/are placed on a web site belonging to the owner of the first computer, in which case step 2 is performed by the user selecting the URL(s) corresponding to the piece(s) of data to which the user wishes to gain access. In this case a user may browse the various pieces of electronic data being offered from various publishers via the first computer. This is similar to browsing in e.g. an ordinary bookstore, and the publishers may have joined marketing assets.

A ‘publisher’ may be a private person having only a limited number of different pieces of electronic data he or she wishes to publish, and/or expecting to distribute only a very limited edition of each piece of data. Alternatively a ‘publisher’ may be e.g. a conventional publishing house using the services of the ‘global publishing house’ in order to save costs for marketing, administration, information technology etc.

The electronic data being distributed may comprise material to be printed, such as books, poems, sheet music, blueprints, drawings etc.

The electronic data may be distributed via a global computer network, such as the internet. Alternatively it may be distributed via a movable storage medium, such as a floppy disc, a CD ROM or any other suitable kind of storage medium.

The features of the seventh aspect of the invention may be combined with any of the features of the first, second, third, fourth, fifth, and sixth aspects of the invention.

The present invention may be used for preventing hacking. This may be obtained in the following way.

The most common way of attacking (hacking) software programs is for a hacker to debug the executable program code using a debugger to insert breakpoints. When the debugger reaches the breakpoint program execution is halted. The hacker then executes instructions, step by step, learning the operation of the program code. With enough effort the hacker understands the code and can then disable the program code which for example is designed to prevent software piracy. A clever program could attempt to discover the hacking attempt by timing the time spent in various parts of the program. If the program is being debugged a function will take several seconds or minutes, whereas it might just take a few milliseconds if not being debugged. However, the hacker can also find and disable the code attempting to time his hacking attempts.

However, if the hacker debugging the program is required to get a decryption key via a network, as in the technology of the present invention, the server can measure the frequency of and the time spent between online requests and hence detect hacking attempts. If these decryption keys are furthermore used to decrypt executable program code, hacking becomes nearly impossible.

The invention further relates to a computer program system for distributing electronic data via a computer network, said electronic data originating from a plurality of publishers, the computer program system being adapted to:

1: cause each of the plurality of publishers to make electronic data available from a first computer being connected to the computer network,

2: cause the first computer to distribute electronic data to users on demand, and

3: cause the first computer to control the usage of the electronic data being made available to each user.

It should be understood that the computer program system may further be adapted to perform any of the operations discussed above and below in connection with the methods of the present invention.

The invention further relates to a computer readable data carrier loaded with such a computer program system, and to a computer system operatively connected to such a computer readable data carrier.

### BRIEF DESCRIPTION OF THE DRAWINGS

FIG. 1 shows a flow diagram of the methods according to the first and second aspects of the invention,

FIG. 2 is a schematic overview of the encryption, transmission and output process according to the first and second aspects of the invention,

FIG. 3 is a schematic overview of the authorization process,

FIG. 4 shows a design of a hardware processor containing an inaccessible part, and the steps of the method of decrypting data according to the sixth aspect of the invention,

FIG. 5 is a schematic overview of the distribution of electronic data according to the seventh aspect of the invention, and

FIG. 6 shows a detail of FIG. 5.

### DETAILED DESCRIPTION OF THE DRAWINGS

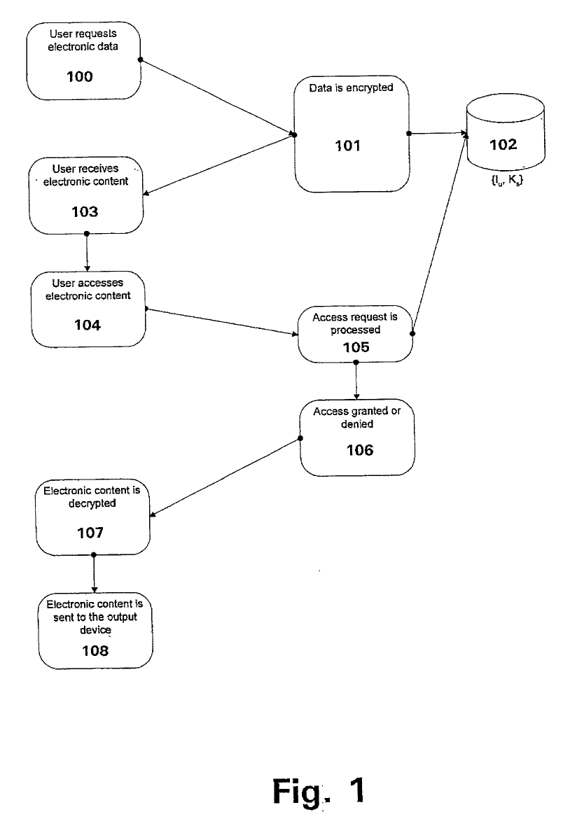

FIG. 1 is a flow diagram showing the principles of the method according to the first and second aspects of the invention. At 100 the user, who wishes to access the data, requests the electronic data using a client computer device. In response to this a server device encrypts the requested data at 101 in order to prepare the data for transmission to the client computer device. The data is encrypted using a secret random encryption key, K_{g}, having a corresponding decryption key, K_{d}. The encrypted data is then branded with an identifier, Iᵤ, and K_{g} (or alternatively or additionally K_{d}) and Iᵤ are stored in a database 102 in the server device. Optionally, additional information relating to the transmission/request and/or to the user may be stored along with K_{g} (and/or K_{d}) and Iᵤ.

A package containing the encrypted and branded electronic content and Iᵤ is then transmitted to the client computer device where the user receives the package at 103, and attempts to access the package at 104. In doing so the user requests K_{d} from the server device by transmitting Iᵤ and optionally additional information, such as credit card information or information relating to the computer or any other suitable information as previously described. The request is processed by the server device at 105, during which the server device consults the database 102 in order to link Iᵤ to K_{g}/K_{d} in the database 102. In case additional information has been provided this additional information is stored in the database 102 along with Iᵤ and K_{g}/K_{d}, and may be used later to determine whether access to the data should be granted or not. Initially the server device determines whether the information provided in the database 102 is sufficient to either grant or deny access to the data. If the information is regarded as being insufficient the serve, device may request additional user information which may subsequently be provided either by the client computer device directly or by the user entering the information.

When the server device has sufficient information to determine whether access should be granted or not, access is granted or denied at 106, and the server subsequently transmits either K_{d} or a notification that access is denied to the user. Grant/deny information is stored in the database 102 along with Iᵤ. In case access is granted the user then decrypts he encrypted data at 107 using the received K_{d}, and the decrypted data is finally sent to he output device at 108.

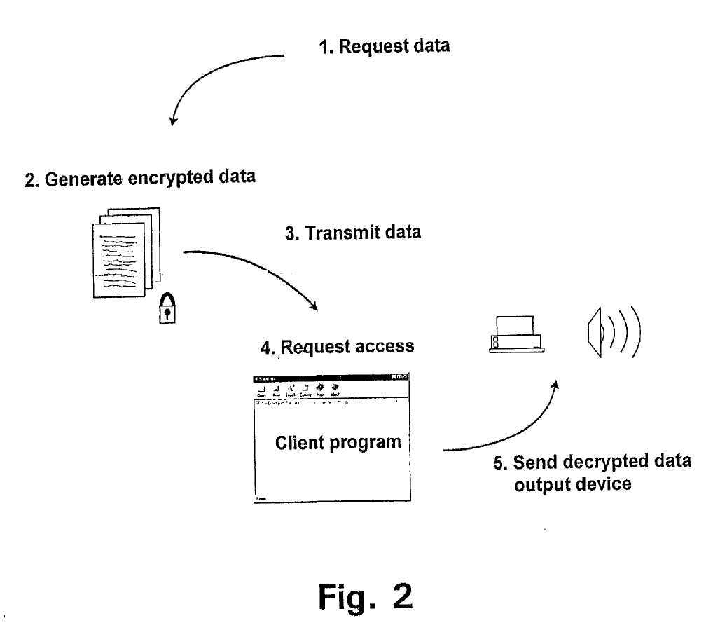

FIG. 2 is a more schematic overview of the encryption, transmission and output process as described above. At 1 the data is requested by the user, at 2 the data is encrypted by the server device, indicated by the lock, and at 3 the encrypted data is transmitted from the server device to the user. At 4 access is requested by the user. This request is performed using a client program which is initially installed at the client computer device. In case access is granted as described above the client program decrypts the data and send the decrypted data to the output device. The output device is depicted as a printer and a loudspeaker so as to indicate that the output device may be any suitable kind of output device depending on the nature of the data being output. This has previously been described.

In this embodiment of the invention it is necessary to install the client program to gain access to the data, since the client program controls all the communication between the client computer device and the server device, the decryption process and the output process.

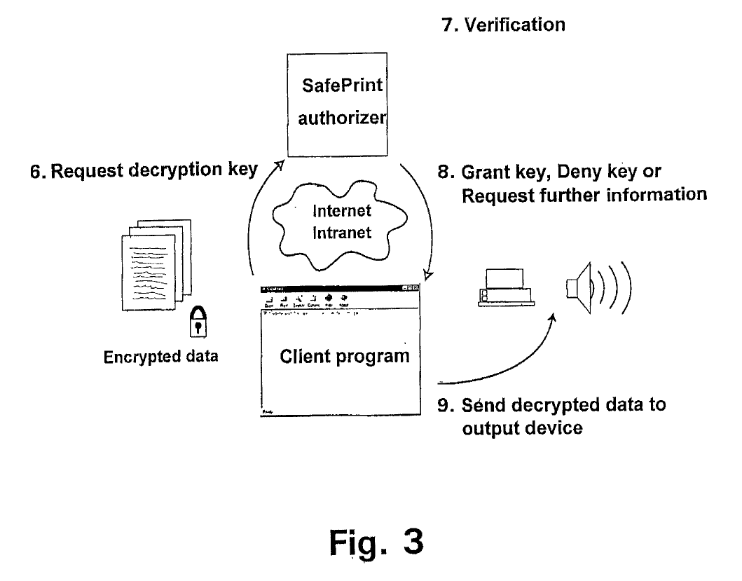

FIG. 3 is a schematic overview of the authorization process illustrating the steps taken after the encrypted data has been received by the client computer device. At 6 the client program requests the decryption key from the server device. The request is transmitted via a computer network connecting the two computers. The computer network may be a local computer network, such as an intranet, or it may be a global computer network, such as the internet. The server device subsequently verifies the client computer device and/or the user at 7 by means of an authorization program, here indicated as ‘SafePrint authorizer’. The verification process may be based upon information such as the number of times the data has already been accessed, the ID of the client computer device, the expiry date for the data, or any other suitable kind of information or criteria as has already been described.

Based upon the information available the authorization program either grants the decryption key, denies the decryption key or requests further information at 8. In case further information is requested, the verification process is performed again when such information has been provided.

In case the key is eventually granted the client program decrypts the data and sends the decrypted data to the output device at 9.

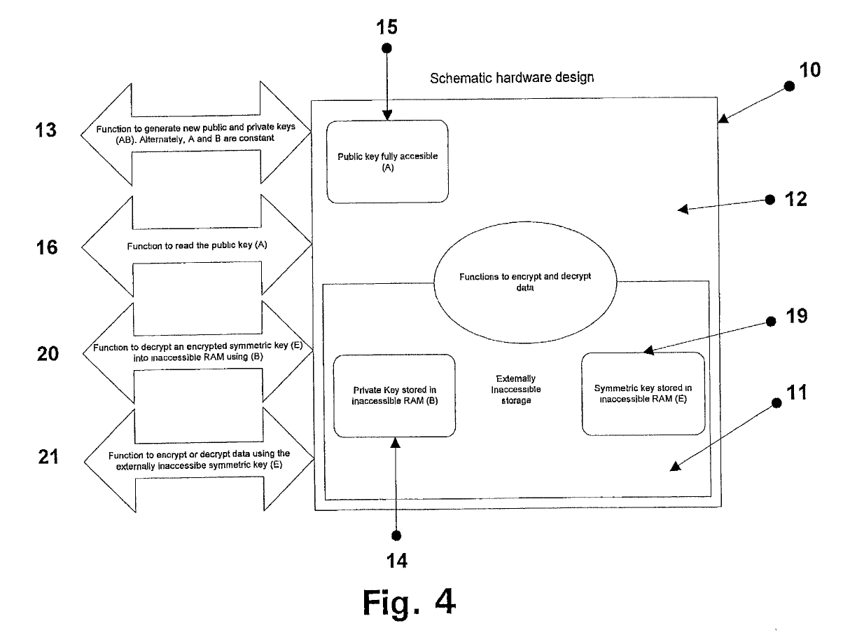

FIG. 4 shows a design of a hardware processor 10 having an externally inaccessible part 11 and an externally accessible part 12. The hardware processor 10 may be used for decrypting data in the following way.

Initially a public/private key pair (AB) is generated by the hardware processor at 13. Alternatively, the key pair (AB) is constant, i.e. the same key pair (AB) is used every time data is to be decrypted or a new key pair (AB) is generated at fixed time intervals, e.g. once every month or once for every 50 log-ons etc. The private part (B) of the key pair (AB) is stored in the externally inaccessible part 11 of the hardware processor 10 as indicated at 14, while the public part (A) of the key pair (AB) is stored. In the externally accessible part 12 of the hardware processor 10 as indicated at 15. Thus, the public part (A) of the key pair (AB) is fully accessible, while the private part (B) of the key pair (AB) is not directly accessible, neither by the person using the computer comprising the hardware processor 10 nor by any other person who may gain access to said computer, e.g. via a computer network connection.

Next the public part (A) of the key pair (AB) is read by an external processor (not shown). This is preferably done by the hardware processor 10 outputting the public part (A) to the external processor, e.g. via a computer network connection. This step is indicated at 16. The step is performed in order to allow the external processor to encrypt an encryption key (E) having been used for encrypting data to be sent to the hardware processor 10. The encryption of the encryption key (E) is performed using the public part (A) of the key pair (AB).

Then the encrypted encryption key (E) as well as the encrypted data are sent to the hardware processor 10. The encryption key (E) is decrypted into the externally inaccessible part 11 of the hardware processor 10, i.e. the decrypted encryption key (E) is at no time directly accessible. This is indicated at 19 and 20. Thus it is ensured that the key (E) may only be used for decrypting the encrypted data to the extend that permission is given.

Finally the encrypted data is decrypted using the decrypted key (E) as indicated at 21.

Alternatively, the data may be directly encrypted in the external processor using the public part (A) of the key pair (AB), in which case the data is of course directly decrypted using (A), as indicated at 22.

In case (E) is a symmetric key it may be used for encryption as well as decryption of data when it has been stored in the hardware processor.

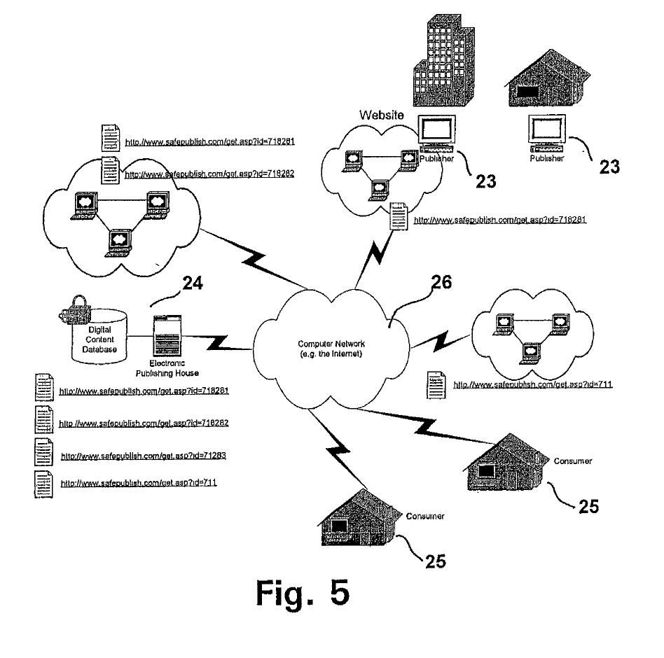

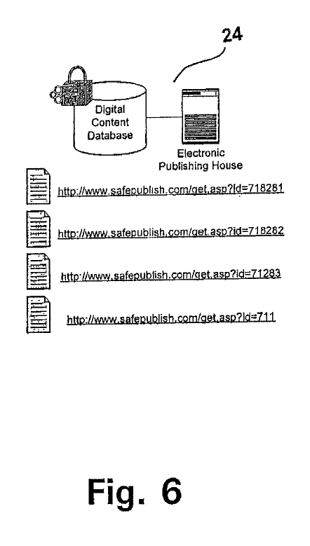

FIG. 5 and 6 show a schematic overview of the distribution of electronic data according to the seventh aspect of the invention. FIG. 5 shows how electronic publishers 23 have placed their works on the electronic publishing house server 24. The works are then made available for consumer download through all kinds of different websites, simply by using the URL associated with the electronic work of interest. The URLs are indicated for the various documents in the Figure. The different kinds of websites may e.g. be the homepage of a specific publisher 23 or it may be a website associated with the electronic publishing house 24. The electronic publishing house 24, the publishers 23 and the consumers 25 are interconnected via a computer network 26.

The electronic publishing house 24 manages the distribution of the works, the receipt of payment from the customers 25 and the distribution of payment to the publishers 23. It may do so in accordance with instructions given by the individual publisher 23, This may be done in the following manner.

When a publisher 23 uploads electronic data to the electronic publishing house 24, the publisher 23 decides the usage price and conditions based on what is generally possible for the electronic publishing house 24. These options may vary greatly—some works may be available for rent, subscription, and usage or to own. The price will likewise vary greatly depending on the aforementioned terms of the sale and the value proposition of the electronic data. The publisher 23 may also choose what payment methods are acceptable.

For example, a publisher 23 may publish a book for sale to be printed. The book may be printed once from one computer. The price is $7.98 and can be paid with credit cards only. Or perhaps a publisher 23 may publish a musical file, such as an MP3 song, for audio playback. The cost is 0.1 cent per usage and can be paid only through electronic wallets.

The electronic publishing house 24 may offer a wide variety of payment methods, such as credit cards, milli-cents and its own account system, in effect acting as a bank. Consumers 25 could then deposit money into a consumer account in effect allowing purchases of cheap works, such as e.g. the aforementioned song.

The electronic publishing house 24 will regularly perform accounting with the publishers 23. Likely the electronic publishing house 24 will deduct a transaction fee form the total amount sold. Such a transaction fee may be a fixed fee, such as a certain amount per month or a certain amount per sold item, or it may be a percentage of the total amount charged from the consumers 25 and relating to the publisher 23 in question. Alternatively, it may be a combination, such as a fixed fee per month supplemented by a fixed percentage as described above.

Publishers 23 can at any time view usage, accounting and download statistics for their published works.

Publishers 23 can range from creative individuals to large publishing houses merely wishing to use the electronic publishing house 24 as a service. This is indicated by the large and the small houses.

This invention allows anyone in the world to instantly publish and sell electronic data in a controlled manner.

FIG. 6 shows the electronic publishing house 24 also shown in FIG. 5. The Figure shows how all stored electronic data is accessible through a single URL.

Thus, a method of providing electronic data from a first computer to a second computer has been provided which prevents as well as discourages wrongful redistribution of electronically obtained data. This object is obtained by ensuring that the decryption key is only provided by the first computer on demand. The decryption key, which is necessary for gaining access to the data in a decrypted form, is rendered unfit for use after the decryption of the data, i.e. the decryption key can only be obtained and used temporarily, and can not be accessed directly by the user. Furthermore, the person who has legally obtained the encryption can not decrypt the data more times than he/she is allowed to, since the decryption key is only provided on demand in a controlled manner. Alternatively, the object may be obtained by ensuring that the decrypted data is not stored in its entirety in the second computer or in any hardware being directly connected to the second computer, including the output device. Thus, the decrypted data can not be accessed unknowingly or passed on to a third party. Th object may also be obtained by storing the decryption key in an inaccessible part of a hardware processor of the second computer.

Furthermore, a method of distributing electronic data via a computer network has been provided, where the distribution can be managed in a controlled manner so that only a correct number of copies is distributed to a specific recipient, and so that wrongful redistribution of electronically obtained data is prevented as well as discouraged. This is obtained by letting an electronic publishing house manage the distribution of the electronic data in a way as described above.

1. A method of providing electronic data from a first computer to a second computer, the method comprising the steps of:
1: at least partially encrypting the data with an encryption key (K_{g}) in the first computer, said encryption key (K_{g}) having a corresponding decryption key (K_{d}),
2: communicating the at least partially encrypted data from the first computer to the second computer,
3: the second computer requesting the decryption key (K_{d}) from the first computer,
4: the first computer providing the decryption key (K_{d}) to the second computer,
5: the second computer decrypting the at least partially encrypted data using the decryption key (K_{d}),
6: rendering the decryption key (K_{d}) unfit for use,
7: outputting the data to an output device.

2. A method according to claim 1, wherein step 2 further comprises the step of branding the at least partially encrypted data with an identifier (Iᵤ) in the first computer, and wherein step 3 is performed by the second computer providing the identifier (Iᵤ).

3. A method according to claim 1, wherein step 6 comprises deleting the decryption key (K_{d}) from the second computer after step 5 has been performed.

4. A method according to claim 1, wherein step 6 comprises storing the decryption key (K_{d}) in a volatile memory of the second computer only.

5. A method according to claim 1, wherein step 4 comprises the steps of
determining whether the second computer fulfils one or more predetermined criteria selected from a group of criteria,
providing the decryption key (K_{d}) only if the second computer fulfils one or more of said predetermined criteria.

6. A method according to claim 5, wherein the determining step comprises determining whether the second computer fulfils one or more criteria selected from the group of criteria consisting of,
the time elapsed between the encryption of the data and the request for the decryption key (K_{d}) does not exceed a predetermined time interval,
the decryption key (K_{d}) has not been requested more than a predetermined number of times,
the second computer is a predetermined computer,
valid payment has been provided,
the hardware being used by the second computer is a predetermined hardware,
the e-mail address of the user is a predetermined e-mail address,
the user name of the user is a predetermined user name,
the output device is a predetermined type of output device,
the output device driver is a predetermined output device driver,
the network ID is a predetermined network ID.

7. A method according to claim 1, wherein step 1 is performed using a random secret encryption key.

8. A method according to claim 1, wherein step 4 is performed using an encrypted session between the first computer and the second computer.

9. A method according to claim 1, wherein step 7 is performed by dividing the at least partially encrypted data into a number of subparts, each subpart in turn being output to an output device.

10. A method according to claim 9, wherein step 7 is performed at least substantially simultaneously with step 5, in such a way that each subpart of the data is in turn decrypted and output to the output device.

11. A method according to claim 10, wherein step 7 is performed by streaming the data to the output device.

12. A method according to claim 1, further comprising the step of providing payment to the first computer.

13. A method according to claim 12, wherein the step of providing payment comprises the step of charging a credit card.

14. A method according to claim 13, wherein the step of charging a credit card further comprises the steps of:
entering relevant credit card data,
the first computer checking whether the corresponding credit card is valid and chargeable.

15. A method according to claim 1, further comprising the steps of
a: the second computer re-requesting the decryption key (K_{d}),
b: the first computer providing the decryption key (K_{d}) to the second computer,
c: the second computer decrypting the at least partially encrypted data,
d: rendering the decryption key (K_{d}) unfit for use,
e: outputting the data to an output device.

16. A method according to claim 15, wherein step d comprises deleting the decryption key (K_{d}) from the second computer after the data has been output to the output device.

17. A method according to claim 15, further comprising the step of providing payment to the first computer.

18. A method according to claim 17, wherein the step of providing payment comprises the step of charging a credit card.

19. A method according to claim 18, wherein the step of charging a credit card further comprises the steps of:
entering relevant credit card data,
the first computer checking whether the corresponding credit card is valid and chargeable.

20. A method according to claim 1, comprising the step of providing electronic data from a server device to a client device.

21. A method according to claim 1, further comprising the steps of:
the first computer requesting additional information from the second computer,
the second computer providing said additional information,
the first computer using said additional information for determining whether to provide the decryption key (K_{d}) or not.

22. A method according to claim 21, wherein the step of the second computer providing said additional information comprises the step of the user providing at least some of said additional information.

23. A computer program system for providing electronic data from a first computer to a second computer, the computer program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer
3: provide a request for the decryption key (K_{d}) from the second computer to the first computer,
4: cause the first computer to provide the decryption key (K_{d}) to the second computer,
5: cause the second computer to decrypt the at least partially encrypted data using the decryption key (K_{d}),
6: render the decryption key (K_{d}) unfit for use,
7: output the data to an output device.

24. A computer readable data carrier loaded with a computer program system for providing electronic data from a first computer to a second computer, the computer program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer,
3: provide a request for the decryption key (K_{d}) from the second computer to the first computer,
4: cause the first computer to provide the decryption key (K_{d}) to the second computer,
5: cause the second computer to decrypt the at least partially encrypted data using the decryption key (K_{d}),
6: render the decryption key (K_{d}) unfit for use,
7: output the data to an output device.

25. A computer system operatively connected to a computer readable data carrier loaded with a computer program system for providing electronic data from a first computer of the computer system to a second computer of the computer system, the computer system and the program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer,
3: provide a request for the decryption key (K_{d}) from the second computer to the first computer,
4: cause the first computer to provide the decryption key (K_{d}) to the second computer,
5: cause the second computer to decrypt the at least partially encrypted data using the decryption key (K_{d}),
6: render the decryption key (K_{d}) unfit for use,
7: output the data to an output device.

26. A method of providing electronic data from a first computer to a second computer, the method comprising the steps of:
1: at least partially encrypting the data with an encryption key (K_{g}) in the first computer, said encryption key (K_{g}) having a corresponding decryption key (K_{d}),
2: the second computer requesting the decryption key (K_{d}) from the first computer,
3: the first computer providing the decryption key (K_{d}) to the second computer,
4: communicating the at least partially encrypted data from the first computer to the second computer,
5: the second computer concurrently receiving and decrypting, by means of a decryption computer program, the at least partially encrypted data, and outputting the data to a selected data output computer program for outputting a signal representative of the decrypted data to a selected software program or hardware device, the data output computer program being known to render the decrypted data unfit for use after output thereof to the selected software program or hardware device,
6: rendering the decrypted data unfit for use.

27. A method according to claim 26, further comprising the step of rendering the decryption key (K_{d}) unfit for use.

28. A method according to claim 26, wherein step 6 is performed concurrently with step 5.

29. A method according to claim 27, wherein the step is performed by deleting the decryption key (K_{d}) from the second computer after step 6 has been performed.

30. A method according to claim 26, wherein step 5 comprises the steps of:
dividing the at least partially encrypted data into a number of subparts,
decrypting each subpart in turn,
outputting each subpart in turn to the selected data output computer program,
outputting a signal representative of each subpart in turn to the selected software program or hardware device,
and wherein step 6 comprises the step of:
rendering each subpart unfit for use after it has been output to the selected data output computer program.

31. A method according to claim 30, wherein each subpart is rendered unfit for use before the subsequent subpart is decrypted.

32. A method according to claim 26, wherein step 5 is performed by outputting the data to a printer device using a printer driver, the printer driver being of a type being known to render the data unfit for use after output thereof to the printer device.

33. A method according to claim 26, wherein step 3 comprises the steps of:
determining whether the second computer fulfils one or more predetermined criteria selected from a group of criteria,
providing the decryption key (K_{d}) only, if the second computer fulfils one or more of said predetermined criteria.

34. A method according to claim 33, wherein the determining step comprises determining whether the second computer fulfils one or more criteria selected from the group of criteria consisting of,
the time elapsed between the encryption of the data and the request for the decryption key (K_{d}) does not exceed a predetermined time interval,
the decryption key (K_{d}) has not been requested more than a predetermined number of times,
the second computer is a predetermined computer,
valid payment has been provided,
the hardware being used by the second computer is a predetermined hardware,
the e-mail address of the user is a predetermined e-mail address,
the user name of the user is a predetermined user name,
the output device is a predetermined type of output device,
the output device driver is a predetermined output device driver,
the network ID is a predetermined network ID.

35. A method according to claim 26, wherein the output device is a printer, and wherein the data is streamed from the second computer to the printer via the selected data output computer program.

36. A computer program system of providing electronic data from a first computer to a second computer, the computer program system being adapted to:
1: at least partially encrypt the data with an encryption key (K_{g}) in the first computer, said encryption key (K_{g}) having a corresponding decryption key (K_{d}),
2: cause the second computer to request the decryption key (K_{d}) from the first computer,
3: cause the first computer to provide the decryption key (K_{d}) to the second computer,
4: communicate the at least partially encrypted data from the first computer to the second computer,
5: cause the second computer to concurrently receive and decrypt, by means of a decryption computer program, the at least partially encrypted data, and output the data to a selected data output computer program outputting a signal representative of the decrypted data to a selected software program or hardware device, and cause the data output computer program to render the decrypted data unfit for use after output thereof to the selected software program or hardware device,
6: render the decrypted data unfit for use.

37. A computer readable data carrier loaded with a computer program system of providing electronic data from a first computer to a second computer, the computer program system being adapted to:
1: at least partially encrypt the data with an encryption key (K_{g}) in the first computer, said encryption key (K_{g}) having a corresponding decryption key (K_{d}),
2: cause the second computer to request the decryption key (K_{d}) from the first computer,
3: cause the first computer to provide the decryption key (K_{d}) to the second computer,
4: communicate the at least partially encrypted data from the first computer to the second computer,
5: cause the second computer to concurrently receive and decrypt, by means of a decryption computer program, the at least partially encrypted data, and output the data to a selected data output computer program for outputting a signal representative of the decrypted data to a selected software program or hardware device, and cause the data output computer program to render the decrypted data unfit for use after output thereof to the selected software program or hardware device,
6: render the decrypted data unfit for use.

38. A computer system operatively connected to a computer readable data carrier loaded with a computer program system of providing electronic data from a first computer of the computer system to a second computer of the computer system, the computer system and the computer program system being adapted to:
1: at least partially encrypt the data with an encryption key (K_{g}) in the first computer, said encryption key (K_{g}) having a corresponding decryption key (K_{d}),
2: cause the second computer to request the decryption key (K_{d}) from the first computer,
3: cause the first computer to provide the decryption key (K_{d}) to the second computer,
4: communicate the at least partially encrypted data from the first computer to the second computer,
5: cause the second computer to concurrently receive and decrypt, by means of a decryption computer program, the at least partially encrypted data, and output the data to a selected data output computer program for outputting a signal representative of the decrypted data to a selected software program or hardware device, and cause the data output computer program to render the decrypted data unfit for use after output thereof to the selected software program or hardware device,
6: render the decrypted data unfit for use.

39. A computer system for providing electronic data comprising
a first computer,
a second computer,
an output device,
the first computer comprising
encryption means for at least partially encrypting data with an encryption key (K_{g}), said encryption key (K_{g}) having a corresponding decryption key (K_{d}),
first communication means for communicating the at least partially encrypted data to the second computer,
providing means for providing the decryption key (K_{d}) to the second computer on request,
the second computer comprising
second communication means for receiving the at least partially encrypted data from the first computer,
requesting and receiving means for requesting and receiving the decryption key (K_{d}) from the first computer,
decryption means for decrypting the at least partially encrypted data,
outputting means for outputting the data to the output device,
means for rendering the decryption key (K_{d}) unfit for use.

40. A computer system according to claim 39, wherein the means for rendering the decryption key (K_{d}) unfit for use comprises deleting means for deleting the decryption key (K_{d}) after the data has been decrypted.

41. A computer system according to claim 39, wherein the first computer is a server device and the second computer is a client device.

42. A computer system according to claim 39, wherein the first communication means comprises a global computer network.

43. A computer system according to claim 39, wherein the second communication means comprises a global computer network.

44. A computer system according to claim 39, wherein the first computer further comprises means for receiving payment.

45. A computer system according to claim 44, wherein the means for receiving payment comprises means for checking the validity and chargeability of a credit card.

46. A computer system according to claim 39, wherein the outputting means for outputting the data to the output device comprises a data output computer program for outputting a signal representative of the decrypted data to a selected software program or hardware device, the data output computer program being known to render the decrypted data unfit for use after output thereof to the selected software program or hardware device.

47. A method of transferring data from a computer system to an output device, the computer system comprising a first computer and a plurality of second computers, said first computer and said second computers being interconnected via a computer network, the data being present at at least one of the second computers, the method comprising the steps of:
1: sending, by means of said at least one second computer, a request to the first computer for permission to output the data to the output device, said request including an identification of the output device,
2: checking, by means of the first computer, whether the output device is an allowed type of output device,
3: the first computer providing an answer to the request to the second computer, the answer including a permission to output the data to the output device if the output device is of an allowed type,
4: if the output device is of an allowed type: outputting the data from the second computer to the output device.

48. A method according to claim 47, wherein step 2 is performed by, by means of the first computer, comparing the type of output device with a predefined positive list of allowed types of output devices, and wherein the answer of step 3 includes a permission to output the data to the output device only if the type of output device is present on said predefined positive list.

49. A method according to claim 47, wherein step 2 is performed by, by means of the first computer, comparing the type of output device with a predefined negative list of not-allowed types of output devices, and wherein the answer of step 3 includes a permission to output the data to the output device only if the type of output device is not present on said predefined negative list.

50. A method according to claim 47, wherein step 2 is performed by, by means of the first computer, checking whether the output device comprises an allowed type of hardware.

51. A method according to claim 47, wherein step 2 is performed by, by means of the first computer, checking whether the output device comprises an allowed type of output driver.

52. A method according to claim 47, wherein the answer of step 3 further includes a decryption key for decrypting encrypted electronic data.

53. A method according to claim 47, the output device comprising a printer, wherein step 4 is performed by printing the data using the printer.

54. A method according to claim 47, wherein the request of step 1 includes an identification of the driver of the output device.

55. A computer program system for transferring data from a computer system to an output device, the computer system comprising a first computer and a plurality of second computers, said first computer and said second computers being interconnected via a computer network, the data being present at at least one of the second computers, the computer program system being adapted to:
1: send, by means of said at least one second computer, a request to the first computer for permission to output the data to the output device, said request including an identification of the output device,
2: check, by means of the first computer, whether the output device is an allowed type of output device,
3: cause the first computer to provide an answer to the request to the second computer, the answer including a permission to output the data to the output device if the output device is of an allowed type,
4: if the output device is of an allowed type: output the data from the second computer to the output device.

56. A computer readable data carrier loaded with a computer program system for transferring data from a computer system to an output device, the computer system comprising a first computer and a plurality of second computers, said first computer and said second computers being interconnected via a computer network, the data being present at at least one of the second computers, the computer program system being adapted to:
1: send, by means of said at least one second computer, a request to the first computer for permission to output the data to the output device, said request including an identification of the output device,
2: check, by means of the first computer, whether the output device is an allowed type of output device,
3: cause the first computer to provide an answer to the request to the second computer, the answer including a permission to output the data to the output device if the output device is of an allowed type,
4: if the output device is of an allowed type: output the data from the second computer to the output device.

57. A computer system operatively connected to a computer readable data carrier loaded with a computer program system for transferring data from a computer system to an output device, the computer system comprising a first computer and a plurality of second computers, said first computer and said second computers being interconnected via a computer network, the data being present at at least one of the second computers, the computer system and the computer program system being adapted to:
1: send, by means of said at least one second computer, a request to the first computer for permission to output the data to the output device, said request including an identification of the output device,
2: check, by means of the first computer, whether the output device is an allowed type of output device,
3: cause the first computer to provide an answer to the request to the second computer, the answer including a permission to output the data to the output device if the output device is of an allowed type,
4: if the output device is of an allowed type: output the data from the second computer to the output device.

58. A method of providing electronic data from a first computer to a second computer, the second computer comprising an output device, the method comprising the steps of:
1: at least partially encrypting the data with an encryption key (K_{g}) in the first computer, said encryption key (K_{g}) having a corresponding decryption key (K_{d}),
2: communicating the at least partially encrypted data from the first computer to the second computer,
3: the second computer requesting the decryption key (K_{d}) from the first computer,
4: checking whether the driver of the output device is an allowed type of driver,
5: the first computer providing the decryption key (K_{d}) to the second computer only if said driver is an allowed type of driver,
6: the second computer decrypting the at least partially encrypted data in case said decryption key (K_{d}) is provided,
7: outputting the decrypted data to the output device.

59. A method according to claim 58, wherein the output device is a printer, and wherein step 7 is performed by printing the data.

60. A method according to claim 58, wherein step 4 is performed by comparing the type of driver with a predefined positive list of allowed types of drivers, and wherein step 5 is only performed if the driver is of a type which is present on said predefined positive list.

61. A method according to claim 58, wherein step 4 is performed by comparing the type of driver with a predefined negative list of not-allowed types of drivers, and wherein step 5 is only performed if the driver is of a type which is not present on said predefined negative list.

62. A method according to claim 58, further comprising the step of rendering the decryption key (K_{d}) unfit for use.

63. A method according to claim 62, wherein the step of rendering the decryption key (K_{d}) unfit for use comprises deleting the decryption key (K_{d}) from the second computer after step 6 has been performed.

64. A method according to claim 62, wherein the step of rendering the decryption key (K_{d}) unfit for use comprises storing the decryption key (K_{d}) in a volatile memory of the second computer only.

65. A method according to claim 58, further comprising the steps of:
the second computer concurrently receiving and decrypting, by means of a decryption computer program, the at least partially encrypted data, and outputting the data to a selected data output computer program for outputting a signal representative of the decrypted data to a selected software program or hardware device, the data output computer program being known to render the decrypted data unfit for use after output thereof to the selected software program or hardware device,
rendering the decrypted data unfit for use.

66. A method according to claim 58, further comprising the steps of:
a: the second computer re-requesting the decryption key (K_{d}),
b: checking whether the driver of the output device is an allowed type of driver,
c: the first computer providing the decryption key (K_{d}) to the second computer only if said driver is an allowed type of driver,
d: the second computer decrypting the at least partially encrypted data in case said decryption key (K_{d}) is provided,
e: outputting the decrypted data to the output device.

67. A method according to claim 66, further comprising the step of, by means of a counter, counting the number of times the decryption key (K_{d}) has been provided to the first computer, said counting step being performed by augmenting said counter each time the decryption key (K_{d}) has been provided to the first computer, step c being performed only if the number of times the decryption key (K_{d}) has previously been requested does not exceed a predetermined number of times.

68. A method according to claim 58, further comprising the steps of:
determining whether the second computer fulfils one or more predetermined criteria selected from a group of criteria,
providing the decryption key (K_{d}) only if the second computer fulfils one or more of said predetermined criteria.

69. A method according to claim 68, wherein the determining step comprises determining whether the second computer fulfils one or more criteria selected from the group of criteria consisting of,
the time elapsed between the encryption of the data and the request for the decryption key (K_{d}) does not exceed a predetermined time interval,
the decryption key (K_{d}) has not been requested more than a predetermined number of times,
the second computer is a predetermined computer,
valid payment has been provided,
the hardware being used by the second computer is a predetermined hardware,
the e-mail address of the user is a predetermined e-mail address,
the user name of the user is a predetermined user name,
the network ID is a predetermined network ID.

70. A computer program system for providing electronic data from a first computer to a second computer, the second computer comprising an output device, the computer program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer,
3: cause the second computer to request the decryption key (K_{d}) from the first computer,
4: check whether the driver of the output device is an allowed type of driver,
5: cause the first computer to provide the decryption key (K_{d}) to the second computer only if said driver is an allowed type of driver,
6: cause the second computer to decrypt the at least partially encrypted data in case said decryption key (K_{d}) is provided,
7: output the decrypted data to the output device.

71. A computer readable data carrier loaded with a computer program system for providing electronic data from a first computer to a second computer, the second computer comprising an output device, the computer program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer,
3: cause the second computer to request the decryption key (K_{d}) from the first computer,
4: check whether the driver of the output device is an allowed type of driver,
5: cause the first computer to provide the decryption key (K_{d}) to the second computer only if said driver is an allowed type of driver,
6: cause the second computer to decrypt the at least partially encrypted data in case said decryption key (K_{d}) is provided,
7: output the decrypted data to the output device.

72. A computer system operatively connected to a computer readable data carrier loaded with a computer program system for providing electronic data from a first computer to a second computer, the second computer comprising an output device, the computer system and the computer program system being adapted to:
1: at least partially encrypt the data with an encryption key (K_{g}) in the first computer, said encryption key (K_{g}) having a corresponding decryption key (K_{d}),
2: communicate the at least partially encrypted data from the first computer to the second computer,
3: cause the second computer to request the decryption key (K_{d}) from the first computer,
4: check whether the driver of the output device is an allowed type of driver,
5: cause the first computer to provide the decryption key (K_{d}) to the second computer only if said driver is an allowed type of driver,
6: cause the second computer to decrypt the at least partially encrypted data in case said decryption key (K_{d}) is provided,
7: output the decrypted data to the output device.

73. A method of decrypting data, the method utilising a hardware processor containing an inaccessible part, the method comprising, by means of said hardware processor:
storing, in the hardware processor, an encryption/decryption key (AB) comprising a public part (A) and a corresponding private part (B), the private part (B) of the key (AB) being stored in the inaccessible part of the hardware processor,
outputting the public part (A) of the key (AB) to an external processor or program,
receiving, from said external processor, an encrypted decryption key (E) which is encrypted by means of the public part (A) of the key (AB),
decrypting key (E) into the inaccessible part of the hardware processor by using the private part (B),
receiving data encrypted with encryption key (E),
decrypting the data using the decrypted key (E),
outputting the decrypted data.

74. A method according to claim 73, wherein the outputting step is performed by outputting the decrypted data to an output device.

75. A method according to claim 73, further comprising the step of encrypting the key (E) externally to the hardware processor.

76. A method according to claim 73, further comprising the step of encrypting the data with an encryption key corresponding to the decryption key (E) externally to the hardware processor.

77. A method according to claim 73, further comprising the step of, by means of the hardware processor, generating and storing the encryption/decryption key (AB) in the hardware processor.

78. A method according to claim 73, further comprising the step of rendering the decryption key (E) unfit for use after the data has been decrypted.

79. A method according to claim 78, wherein the step of rendering the decryption key (E) unfit for use comprises deleting the decryption key (E) from the hardware processor.

80. A computer program system for decrypting data, the computer program system being adapted to co-operate with a hardware processor containing an inaccessible part, the computer program system being further adapted to, in co-operation with the hardware processor:
store, in the hardware processor, an encryption/decryption key (AB) comprising a public part (A) and a corresponding private part (B), the private part (B) of the key (AB) being stored in the inaccessible part of the hardware processor,
output the public part (A) of the key (AB) to an external processor or program,
receive, from said external processor, an encrypted decryption key (E) which is encrypted by means of the public part (A) of the key (AB),
decrypt key (E) into the inaccessible part of the hardware processor by using the private part (B),
receive data encrypted with encryption key (E),
decrypt the data using the decrypted key (E),
output the decrypted data.

81. A computer readable data carrier loaded with a computer program system for decrypting data, the computer program system being adapted to co-operate with a hardware processor containing an inaccessible part, the computer program system being further adapted to, in co-operation with the hardware processor:
store, in the hardware processor, an encryption/decryption key (AB) comprising a public part (A) and a corresponding private part (B), the private part (B) of the key (AB) being stored in the inaccessible part of the hardware processor,
output the public part (A) of the key (AB) to an external processor or program,
receive, from said external processor, an encrypted decryption key (E) which is encrypted by means of the public part (A) of the key (AB),
decrypt key (E) into the inaccessible part of the hardware processor by using the private part (B),
receive data encrypted with encryption key (E),
decrypt the data using the decrypted key (E),
output the decrypted data.

82. A computer system operatively connected to a computer readable data carrier loaded with a computer program system for decrypting data, the computer system and the computer program system being adapted to co-operate with a hardware processor containing an inaccessible part, the computer system and the computer program system being further adapted to, in co-operation with the hardware processor:
store, in the hardware processor, an encryption/decryption key (AB) comprising a public part (A) and a corresponding private part (B), the private part (B) of the key (AB) being stored in the inaccessible part of the hardware processor,
output the public part (A) of the key (AB) to an external processor or program,
receive, from said external processor, an encrypted decryption key (E) which is encrypted by means of the public part (A) of the key (AB),
decrypt key (E) into the inaccessible part of the hardware processor by using the private part (B),
receive data encrypted with encryption key (E),
decrypt the data using the decrypted key (E),
output the decrypted data.

83. An electronic processor containing an inaccessible part, and being adapted to, in cooperation with a computer program system, to decrypt data and to:
store, in the hardware processor, an encryption/decryption key (AB) comprising a public part (A) and a corresponding private part (B), the private part (B) of the key (AB) being stored in the inaccessible part of the hardware processor,
output the public part (A) of the key (AB) to an external processor or program,
receive, from said external processor, an encrypted decryption key (E) which is encrypted by means of the public part (A) of the key (AB),
decrypt key (E) into the inaccessible part of the hardware processor by using the private part (B),
receive data encrypted with encryption key (E),
decrypt the data using the decrypted key (E),
output the decrypted data.

84. A method of distributing electronic data via a computer network, said electronic data originating from a plurality of publishers, the method comprising the steps of:
1: each of the plurality of publishers making electronic data available from a first computer being connected to the computer network,
2: the first computer distributing electronic data to users on demand, and
3: the first computer controlling the usage of the electronic data being made available to each user.

85. A method according to claim 84, wherein step 3 is performed by counting the number of times the electronic data has been made available, and wherein usage of the data is prevented or limited in case said number of times exceeds a predetermined number of times.

86. A method according to claim 84, wherein step 3 comprises the steps of:
at least partially encrypting the data with an encryption key (K_{g}) in the first computer prior to distributing the data, so that the data is distributed in an encrypted form, said encryption key (K_{g}) having a corresponding decryption key (K_{d}),
the user requesting the decryption key (K_{d}),
the first computer providing the decryption key (K_{d}) to the user,
decrypting the at least partially encrypted data using the decryption key (K_{d}),
rendering the decryption key (K_{d}) unfit for use,
outputting the data to an output device.

87. A method according to claim 86, wherein the step of rendering the decryption key (K_{d}) unfit for use comprises deleting the decryption key (K_{d}).

88. A method according to claim 86, wherein the decryption key (K_{d}) is only provided if the user fulfils one or more predetermined criteria selected from a group of criteria.

89. A method according to claim 88, wherein the group of criteria consists of:
the time elapsed between the encryption of the data and the request for the decryption key (K_{d}) does not exceed a predetermined time interval,
the decryption key (K_{d}) has not been requested more than a predetermined number of times,
the computer used by the user is a predetermined computer,
valid payment has been provided,
the hardware being used by the user is a predetermined hardware,
the e-mail address of the user is a predetermined e-mail address,
the user name of the user is a predetermined user name,
the output device being used by the user is a predetermined type of output device,
the output device driver being used by the user is a predetermined output device driver,
the network ID is a predetermined network ID.

90. A method according to claim 84, further comprising the steps of:
the first computer charging each user for the data made available to the user,
the first computer providing payment to each of the publishers.

91. A method according to claim 90, wherein the amount charged is dependent on the content of the distributed electronic data and on the number of copies made available to the user.

92. A method according to claim 90, wherein the payment to each of the publishers is dependent on the content of the distributed electronic data and on the number of copies being made available to the users.

93. A method according to claim 90, wherein the step of charging each user is performed by charging a credit card of each user.

94. A method according to claim 90, wherein the amount charged is determined by the individual publisher.

95. A method according to claim 90, wherein step 1 is performed by, by means of the first computer, providing a Uniform Resource Locator (URL) corresponding to each piece of electronic data being made available to the respective publisher.

96. A method according to claim 95, wherein the Uniform Resource Locator(s) (URL(s)) is/are placed on a web site belonging to the respective publisher, so as to provide a direct link from said web site to the electronic data.

97. A method according to claim 95, wherein the Uniform Resource Locator(s) (URL(s)) is/are placed on a web site belonging to the owner of the first computer, and wherein step 2 is performed by the user selecting the URL(s) corresponding to the piece(s) of data to which the user wishes to gain access.

98. A method according to claim 84, wherein the electronic data being distributed comprises material to be printed.

99. A method according to claim 84, wherein the electronic data is distributed via a global computer network.

100. A computer program system for distributing electronic data via a computer network, said electronic data originating from a plurality of publishers, the computer program system being adapted to:
1: cause each of the plurality of publishers to make electronic data available from a first computer being connected to the computer network,
2: cause the first computer to distribute electronic data to users on demand, and
3: cause the first computer to control the usage of the electronic data being made available to each user.

101. A computer readable data carrier loaded with a computer program system for distributing electronic data via a computer network, said electronic data originating from a plurality of publishers, the computer program system being adapted to:
1: cause each of the plurality of publishers to make electronic data available from a first computer being connected to the computer network,
2: cause the first computer to distribute electronic data to users on demand, and
3: cause the first computer to control the usage of the electronic data being made available to each user.

102. A computer system operatively connected to a readable data carrier loaded with a computer program system for distributing electronic data via a computer network, said electronic data originating from a plurality of publishers, the computer system and the computer program system being adapted to:
1: cause each of the plurality of publishers to make electronic data available from a first computer being connected to the computer network,
2: cause the first computer to distribute electronic data to users on demand, and
3: cause the first computer to control the usage of the electronic data being made available to each user.
